(19) United States
(12) Patent Application Publication
(10) Pub. No.: US 2023/0297545 A1
(43) Pub. Date: Sep. 21, 2023

(54) INFORMATION PROCESSING APPARATUS, INFORMATION PROCESSING PROGRAM, AND INFORMATION PROCESSING METHOD

(71) Applicant: SHARP KABUSHIKI KAISHA, Sakai City (JP)

(72) Inventor: SHO TSUJIMOTO, Sakai City (JP)

(21) Appl. No.: 18/122,732

(22) Filed: Mar. 17, 2023

(30) Foreign Application Priority Data
Mar. 18, 2022 (JP) 2022-043481

(51) Int. Cl. G06F 16/16; G06F 21/62; H04N 1/32

(52) U.S. Cl. CPC G06F 16/162; G06F 21/6218; H04N 1/32106; G06F 2221/2141; H04N 2201/3208; H04N 2201/218

(57) ABSTRACT

In an information processing system, an information processing apparatus saves mobile address book data of a mobile terminal in a temporary database, and refers to the mobile address book data to execute an image transmission job. When user authentication is not performed to the mobile terminal after the mobile address book data has been referenced, the temporary database is deleted at a first timing at which a reset key is operated on an image transmission screen, a second timing at which the image transmission screen transitions from the image transmission screen transitions to another screen, or a third timing after a predetermined time has elapsed. When the user authentication is performed, the temporary database is deleted at a timing of logging out by an explicit logout operation or an automatic logout due to elapse of a time.

### TECHNICAL FIELD

The present disclosure relates to an information processing apparatus, an information processing program, and an information processing system, and particularly, for example, to an information processing apparatus, an information processing program, and an information processing system that receives data from a mobile terminal by an image processing apparatus (multifunction peripheral) placed at a public space and the like.

### BACKGROUND ART

In the known technology, an address, stored in a mobile phone, of an image forming device and an address, stored in the image forming device, of the mobile phone are deleted after communication between the mobile phone and the image forming device ends.

### SUMMARY

### Technical Problem

In the known technology, when a timing at which the image forming device automatically deletes data is different from a timing intended by a user, the address data needs to be again transferred, which is not convenience.

Thus, a main object of the present disclosure is to provide a novel information processing apparatus, information processing program, and information processing method.

Another object of the present disclosure is to provide an information processing apparatus, an information processing program, and an information processing method that can reduce the possibility of impairing user convenience as much as possible.

### Solution to Problem

In the present disclosure, the following configuration is applied to solve the above problem. Note that the reference signs, supplementary descriptions, and the like in brackets indicate correspondence with embodiments described to aid understanding of the present disclosure and are not intended to limit the present disclosure.

A first disclosure provides an information processing apparatus that saves, in a temporary database, mobile address book data of a mobile terminal, the information processing apparatus including: a job executor that refers to the mobile address book data saved in the temporary database to execute a job; a first determiner that makes a first determination when user authentication is performed on the mobile terminal or makes a second determination when the user authentication is not performed on the mobile terminal; and a deleter that deletes the temporary database at a respective timing in accordance with a determination result of the first determination or the second determination by the first determiner after the job executor finishes referring to the mobile address book data.

According to the first disclosure, an information processing system (10: a reference sign that illustrates a corresponding part in examples, but does not imply limitation; the same applies to the following description) includes an information processing apparatus (12) such as a multifunction peripheral (MFP), for example, and the information processing apparatus executes, for example, an image transmission job in accordance with an operation of a user on a mobile terminal (14). At this time, the information processing apparatus saves, in a temporary database (136c), mobile address book data of the mobile terminal. A job executor (22, S9) refers to the mobile address book data saved in the temporary database to execute the job. A first determiner (22, S41) determines whether user authentication of the information processing apparatus is performed for the user of the mobile terminal. Then, the first determiner makes a first determination when the user authentication is performed or makes a second determination when the user authentication is not performed. A deleter (22, S13) deletes the temporary database at a respective timing in accordance with a determination result of the first determination or the second determination of the first determiner after the job executor finishes referring to the mobile address book data.

According to the first disclosure, the temporary database is deleted at a respective timing depending on whether the user authentication of the information processing apparatus is performed for the user of the mobile terminal, which avoids impairing, as much as possible, the convenience of the user with the user authentication.

A second disclosure provides the information processing apparatus according to the first disclosure, the information processing apparatus further including a second determiner that determines whether the user authenticated has logged out, and when the determination result of the first determiner is the first determination, the deleter deletes the temporary database at a timing at which the second determiner determines that the user has logged out.

According to the second disclosure, a second determiner (22, S43, S47) determines whether the user authenticated has logged out. When the determination result of the first determiner (22, S41) is the first determination, the deleter (22, S13) deletes the temporary database at a timing at which the second determiner determines that the user has logged out.

According to the second disclosure, when user authentication is performed for the user, the temporary database is not deleted against the user's intension, so that the convenience of the user is not impaired.

A third disclosure provides the information processing apparatus according to the first or second disclosure, the information processing apparatus further including: a storage (24, 26) capable of registering the mobile address book data; and a registrator (S27 to S35) that registers the mobile address book data to the storage when the determination result of the first determiner is the first determination, and the mobile address book data is not registered to the storage when the determination result of the first determiner is the second determination.

According to the third disclosure, the mobile address book data can be registered in the storage (24, 26) of the information processing apparatus (12). When the determination result of the first determiner (22, S23) is the first determination, the registrator (22, S27 to S35) registers the mobile address book data in the storage. However, the registrator does not register the mobile address book data in the storage when the determination result of the first determiner is the second determination.

According to the third disclosure, the mobile address book data can be registered in the main body of the information processing apparatus only when user authentication is performed for the user, which further improves the convenience of the user.

A fourth disclosure provides the information processing apparatus according to the third disclosure, in the information processing apparatus, the registrator also registers an access right to the mobile address book data.

According to the fourth disclosure, the registrator (22, S27 to S35) displays, for example, a registration screen (100), and the user sets, through an access right configurator (118) on the registration screen, to whom the access right is granted. According to the setting, the registrator also registers the access right.

According to the fourth disclosure, (presence/absence of) the access right to the mobile address book data is registered along with the mobile address book data, so that the utilization of the registered mobile address book data can be appropriately managed.

A fifth disclosure provides an information processing apparatus according to any one of the first to fourth disclosures, in the information processing apparatus, the deleter deletes the temporary database at any timing of a first timing at which the job is reset, a second timing at which the job is transitioned to another job, and a third timing at which a predetermined time has elapsed, when the determination result of the first determiner is the second determination.

According to the fifth disclosure, the temporary database is forcibly deleted at a respective timing (S49, S51, S53) when the determination result of the first determiner (22, S41) is the second determination, that is, when the user authentication is not performed.

According to the fifth disclosure, the temporary database is forcibly deleted under a predetermined condition regardless of whether or not the user who is not authenticated has logged out, so that the mobile address book data and the like saved in the temporary database can be kept secret from others who will later use the information processing apparatus.

A sixth disclosure provides an information processing program for an information processing apparatus that saves, in a temporary database, mobile address book data of a mobile terminal, the information processing program causing a CPU of the information processing apparatus to operate as: a job executor that refers to the mobile address book data saved in the temporary database to execute a job; a determiner that makes a first determination when user authentication is performed on the mobile terminal or makes a second determination when the user authentication is not performed on the mobile terminal; and a deleter that deletes the temporary database at a respective timing in accordance with a determination result of the first determination or the second determination by the determiner after the job executor finishes referring to the mobile address book data.

A seventh disclosure provides an information processing method performed by an information processing apparatus that saves, in a temporary database, mobile address book data of a mobile terminal, the method including: a job execution step of referring to the mobile address book data saved in the temporary database, to execute a job; a determination step of making a first determination when user authentication is performed on the mobile terminal and making a second determination when the user authentication is not performed on the mobile terminal; and a deletion step of deleting the temporary database at a respective timing in accordance with a determination result of the first determination or the second determination in the determination step after finishing the reference to the mobile address book data in the job execution step.

The same or similar effects as in the first disclosure can be expected in the sixth disclosure and the seventh disclosure.

### Advantage Effects of Disclosure

The temporary database is deleted at a respective timing depending on whether user authentication of the information processing apparatus is performed for the user of the mobile terminal, which avoids impairing, as much as possible, the convenience of the user authenticated.

The aforementioned objects, other objects, features, and advantages of the present disclosure will be further obvious from the detailed description of examples given below with reference to the drawings.

### BRIEF DESCRIPTION OF DRAWINGS

FIG. 1 is a graphic diagram illustrating a configuration of an information processing system according to an example of the present disclosure.

FIG. 2 is a block diagram illustrating an electrical configuration of an information processing apparatus illustrated in FIG. 1.

FIG. 3 is a block diagram illustrating an electrical configuration of a mobile terminal illustrated in FIG. 1.

FIG. 4 is a graphic diagram illustrating an example of an image transmission screen when the information processing apparatus transmits an image to another apparatus according to the example.

FIG. 5 is a graphic diagram illustrating an example of a registration confirmation screen when a mobile address book data of the mobile terminal is registered in the information processing apparatus according to the example.

FIG. 6 is a graphic diagram illustrating an example of a registration screen when mobile address book data is registered in the information processing apparatus according to the example.

FIG. 7 is a graphic diagram illustrating an example of a registration completion screen when registration of the mobile address book data in the information processing apparatus is completed according to the example.

FIG. 8 is a graphic diagram illustrating an example of a memory map of a RAM of the information processing apparatus according to the example.

FIG. 9 is a flowchart illustrating an example of operations of the information processing apparatus that transmits an image according to the example.

FIG. 10 is a flowchart illustrating an example of operations of the information processing apparatus that registers the mobile address book data according to the example.

FIG. 11 is a flowchart illustrating an example of operations for deleting the mobile address book data registered in a temporary database of the information processing apparatus according to the example.

FIG. 12 is a flowchart illustrating an example of operations for displaying a transmission history in the information processing apparatus according to the example.

### DESCRIPTION OF EMBODIMENTS

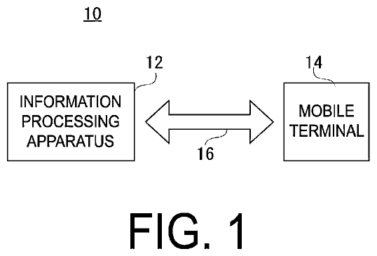

Referring to FIG. 1, in an information processing system 10 according to an example of the present disclosure, a mobile terminal 14 can register data such as a mail address to an information processing apparatus 12 by means of near field communication 16 such as Bluetooth (product name).

The information processing apparatus 12 is a multifunction peripheral (MFP) having a copy function, a printer function, a scanner function, a facsimile (FAX) function, and the like. In this example, the information processing apparatus 12 is placed at a public space and is used by an unspecified number of persons (users). Examples of the public space include a shop such as a supermarket, a restaurant, or a convenience store or a public facility such as a station, a bus terminal, an airport, a government office, or a library is conceivable.

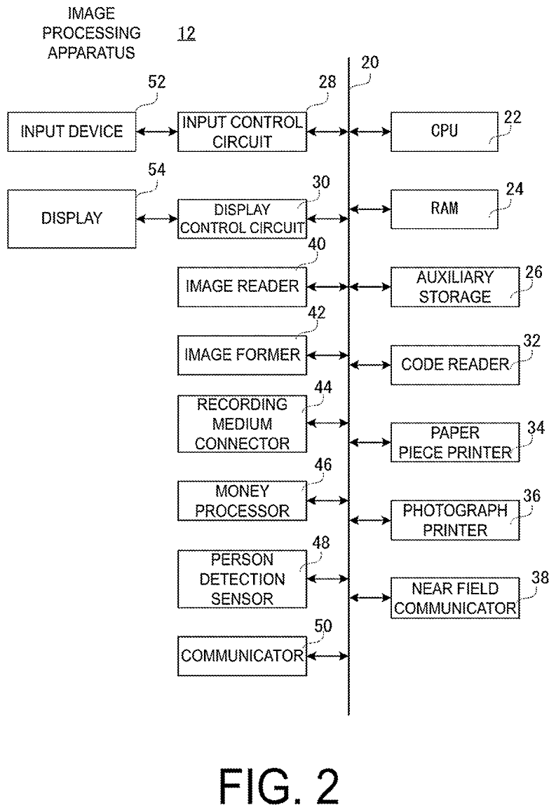

FIG. 2 is a block diagram illustrating an electrical configuration of the information processing apparatus 12 illustrated in FIG. 1. Referring to FIG. 2, the information processing apparatus 12 includes a CPU 22. A RAM 24, an auxiliary storage 26, an input control circuit 28, a display control circuit 30, a code reader 32, a paper piece printer 34, a photograph printer 36, a near field communicator 38, an image reader 40, an image former 42, a storage medium connector 44, a money processor 46, a person detection sensor 48, and a communicator 50 are connected to the CPU 22 via a bus 20. The input control circuit 28 is connected to an input device 52, and the display control circuit 30 is connected to a display 54.

The CPU 22 manages the overall control of the information processing apparatus 12. The RAM 24 is a main storage of the CPU 22 and is used as a work region and a buffer region. For example, a mobile address book data of the mobile terminal 14 can be registered in a temporary database.

The auxiliary storage 26 is an auxiliary storage device of the information processing apparatus 12 for storing a control program and various kinds of data for the CPU 22 to control operations of each component in the information processing apparatus 12. However, a memory such as an HDD is used as the auxiliary storage 26.

The input device 52 is a device for receiving an input operation by a user (user operation) and includes, for example, a touch panel and hardware operation buttons or operation keys (hardware keys). The touch panel may be provided on a display screen of the display 54 or may be provided separately from the display 54. A touch display including the touch panel formed integrally with the display 54 may be provided. When the touch panel is provided on the display screen of the display 54, a graphical user interface (GUI) including a software key such as an icon is displayed on the display 54, and the user operation is received via the GUI.

The input control circuit 28 outputs an operation signal or operation data in response to an operation on the input device 52 to the CPU 22. For example, the input control circuit 28 applies a necessary voltage or the like to the touch panel included in the input device 52, and when a touch operation (touch input) is performed within a touch effective range on the touch panel, the input control circuit 28 outputs, to the CPU 22, touch coordinate data indicating the position of the touch input. The input control circuit 28 outputs, to the CPU 22, an operation signal or operation data in response to an operation on the operation buttons or the hardware keys included in the input device 52.

The display control circuit 30 includes a GPU, a VRAM, and the like, and the GPU generates display image data, in the VRAM, for displaying various screens on the display 54 by using image generation data stored in the RAM 24, and outputs the generated display image data to the display 54 under an instruction from the CPU 22. As the display 54, for example, an LCD or an EL display can be used.

The code reader 32 includes, for example, a laser scanner, a camera, or the like and can read codes or the like applied to a product, a card, a receipt, or the like. The codes that can be read by the code reader 32 include such as a bar code (one-dimensional bar code) and a two-dimensional code (for example, a QR code (tradename)).

The paper piece printer 34 is, for example, a thermal printer (heat sensitive printer) or a dot impact printer and issues a paper piece on which an image is printed, such as a receipt, an acknowledgment, a journal, or a coupon ticket. Specifically, the paper piece printer 34 prints various kinds of character strings, images, code patterns (such as bar codes), and the like on a rolled paper and emits a printed paper piece.

The photograph printer 36 is, for example, a dye sublimation printer or an inkjet printer and performs printing an image on a paper for a photograph (photograph paper). The photograph printed by the photograph printer 36 is emitted to a photograph discharger provided on a side surface of the information processing apparatus 12. As image data for forming an image on a paper, for example, image data stored in a storage medium connected to the storage medium connector 44 or image data transmitted from an external computer such as the mobile terminal 14 is used.

The near field communicator 38 can perform data exchange with the mobile terminal 14 according to Bluetooth (product name), for example.

The image reader 40 includes a light source, a plurality of mirrors, an imaging lens, a line sensor, and the like. The image reader 40 exposes a surface of an original document with the light source and guides reflected light reflected from the surface of the original document to the imaging lens by the plurality of mirrors. Then, the reflected light is formed into an image on the light receiving element of the line sensor by the imaging lens. The line sensor detects luminance and chromaticity of the reflected light forming the image on the light receiving element and generates reading image data based on the image on the surface of the original document.

The image former (printing device) 42 is a general-purpose laser printer, includes a photoreceptor, a charger, an exposure device, a development device, a transfer device, a fixing device, and the like and performs printing an image (printing image) corresponding to the printing image data on a recording sheet (paper). The image former 42 is not limited to a laser printer and may be an inkjet printer.

Note that although detailed description will be omitted, the image former 42 includes a color printing function, and consists of an image forming station including a photoreceptor, a charger, a development device, and the like for each of colors yellow (Y), magenta (M), cyan (C), and black (K).

The storage medium connector 44 includes an attachment unit (for example, a drive and a memory slot) for attaching various storage media. Examples of the storage media include flash memories (for example, a USB memory, an SD memory card, and a memory stick).

The money processor 46 includes a money inlet and a money return port. The money inlet includes a coin inlet port, a bill inlet port, a change return lever, and the like. Coins fed in through the coin inlet port and bills fed in through the bill inlet port are classified by type and are then accommodated in predetermined money storages. The money storage includes a coin storage and a bill storage. When coins or bills are fed in, then the input amount is calculated according to the type and the number of coins accommodated in the coin storage and the type and the number of the bills accommodated in the bill storage.

When a predetermined service or the like is executed by the information processing apparatus 12, then the cost corresponding to the content of the service is subtracted from the input amount, and the balance of the input amount is calculated. When the change return lever is operated, coins or bills are returned according to the balance of the input amount. The coins are returned from the coin return port, and the bills are returned from the bill inlet port.

The person detection sensor 48 is a sensor for detecting whether a person (user) is present in a predetermined region (section) set in front of the information processing apparatus 12 and is, for example, a distance sensor. For example, an infrared sensor, an ultrasonic sensor, or a laser distance sensor is used as the distance sensor. The distance sensor outputs distance data to the CPU 22. The CPU 22 determines whether or not a person is present in the predetermined region in front of the information processing apparatus 12 according to whether the distance indicated by the distance data output from the person detection sensor 48 is within a predetermined distance that defines the predetermined region.

The communicator 50 is a communication circuit for establishing connection to a network (not illustrated). The communicator 50 includes a wired communication circuit or a wireless communication circuit and performs communication with an external computer (external terminal) via the network on the basis of a communication scheme that follows a known communication scheme in accordance with an instruction from the CPU 22.

The electrical configuration of the information processing apparatus 12 illustrated in FIG. 2 is merely an example, and the configuration is not limited thereto.

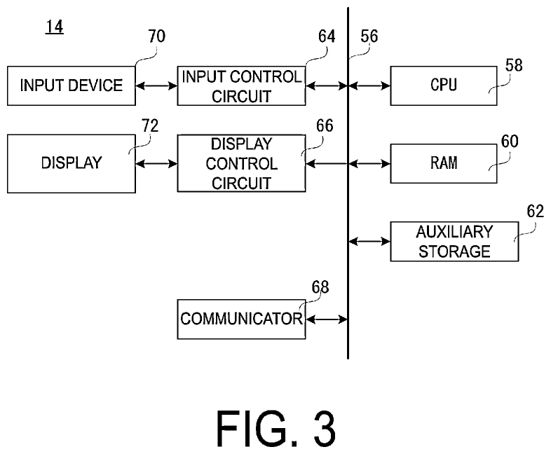

FIG. 3 is a block diagram illustrating an electrical configuration of the mobile terminal 14 illustrated in FIG. 1. Referring to FIG. 3, the mobile terminal 14 includes a CPU 58. A RAM 60, an auxiliary storage 62, an input control circuit 64, a display control circuit 66, and a communicator 68 are connected to the CPU 58 via a bus 56. An input device 70 is connected to the input control circuit 64, and a display 72 is connected to the display control circuit 66.

The CPU 58 manages the overall control of the mobile terminal 14. The RAM 60 is used as a work region and a buffer region of the CPU 58. The auxiliary storage 62 is an auxiliary storage device of the mobile terminal 14, such as a micro SD card, for example.

The input control circuit 64 outputs an operation signal or operation data in response to an operation on the input device 70 to the CPU 58. For example, the input control circuit 64 applies a necessary voltage or the like to the touch panel included in the input device 70, and when a touch operation (touch input) is performed within a touch effective range of the touch panel, the input control circuit 64 outputs, to the CPU 58, touch coordinate data indicating the position of the touch input.

The display control circuit 66 includes a GPU, a VRAM, and the like, and the GPU generates display image data, in the VRAM, for displaying various screens by using image generation data stored in the RAM 60, and outputs the generated display image data to the display 72 under an instruction from the CPU 58. As the display 72, an LCD or an EL display can be used.

The communicator 68 includes a wireless communication circuit and a near field communication circuit such as Bluetooth for establishing connection to a network (not illustrated), can communicate with an external computer via the network or can communicate directly with the information processing apparatus 12 or the like via Bluetooth, for example, in accordance with an instruction from the CPU 58.

Note that the electrical configuration of the mobile terminal 14 illustrated in FIG. 3 is merely an example, and the configuration is not necessarily limited thereto.

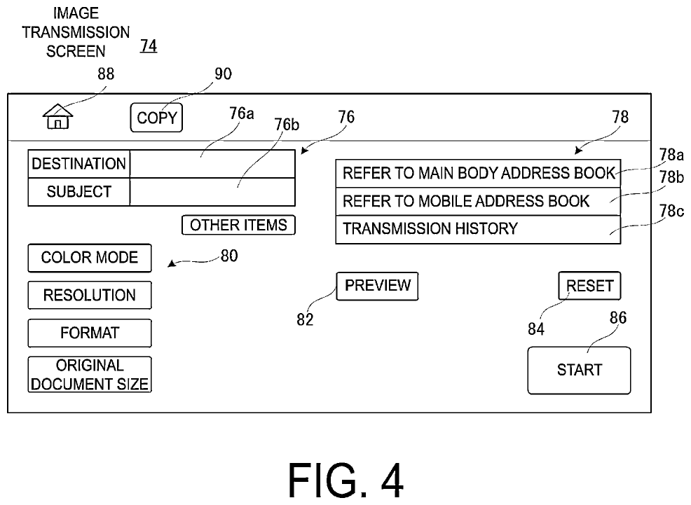

FIG. 4 illustrates an example of an image transmission screen in a case where an image is transmitted to outside like, for example, facsimile transmission or email transmission from the information processing apparatus 12 illustrated in FIGS. 1 and 2.

An image transmission screen 74 illustrated in FIG. 4 is a GUI displayed on the display 54 (FIG. 2) when image transmission is executed, and an inputter 76 is provided therein. The inputter 76 includes a destination inputter 76a for inputting a facsimile number or a mail address of a destination and a title inputter 76b for inputting a title. An address referencer 78 is provided on the right side of the inputter 76.

The address referencer 78 includes a main body address reference key 78a that instructs to refer to the main body address book registered in, for example, the auxiliary storage 26 (FIG. 2) of the information processing apparatus 12, and a mobile address reference key 78b that refers to the mobile address book registered in the mobile terminal 14. The address referencer 78 further includes a transmission history reference key 78c that refers to an address by displaying a past transmission history.

The transmission history reference key 78c can display only the transmission history performed by the user only when the user authentication is performed. Displaying the transmission history improves convenience in a case of repeating image transmission and in a case of transmitting the same image data to different destinations.

The image transmission screen 74 further includes a configurator 80, and a color mode, resolution, a format, an original document size, and the like of an image to be transmitted can be set by the configurator 80.

A preview key 82 for previewing a result of the setting by the configurator 80 and a reset key 84 for resetting the result of the setting by the configurator 80 are further provided.

A start key 86 is operated to start execution of image transmission of which details are set in this manner.

Note that a home icon 88 is an icon that is touched to return to a home screen and a copy key 90 is a key for providing an instruction to change an image transmission function to a copy function.

When the reset key 84 on the lower right side is operated on the image transmission screen 74, a selecting condition of each function such as a destination, a title, a color mode, and resolution in the inputter 76 is reset. At this time, if the mobile address book data of the mobile terminal 14 is saved in the temporary database 136c (which will be described below) in the RAM 24 (FIG. 2), the mobile address book data is deleted at the same time when the reset key 84 is operated.

When the home icon 88 or the copy key 90 on the upper left side is operated, transition to the home screen or the copy screen is performed, respectively. If the mobile address book data of the mobile terminal 14 is saved in the temporary database 136c of the RAM 24, the mobile address book data is deleted at the same time when transition to a screen other than a screen for image transmission in response to such an operation.

Note that when no operation is performed on the image transmission screen 74 for a specific period of time, the mobile address book data is automatically deleted.

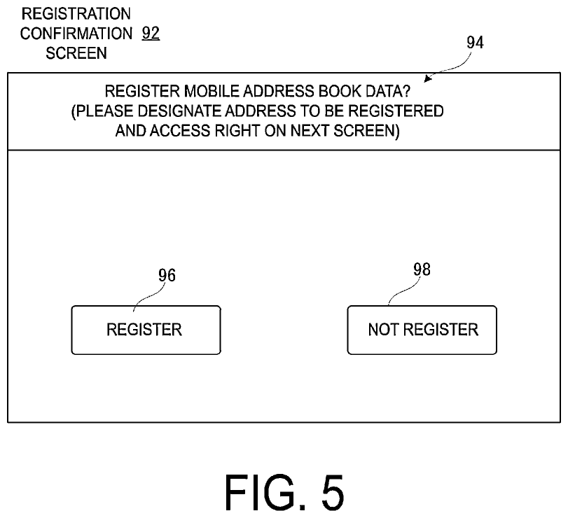

FIG. 5 illustrates an example, in the information processing apparatus 12, of a registration confirmation screen displayed on the display 54 for confirming whether to register the mobile address book data saved in the temporary database 136c in, for example, an HDD included in the auxiliary storage 26. However, this dialog is not displayed in a case where the user authentication is not performed, and the dialog is displayed only when the user authentication is performed.

On the registration confirmation screen 92, a message 94 “do you want to register mobile address book data?” is displayed to cause the user to confirm whether to register the mobile address book data in the main body of the information processing apparatus 12.

The user operates the registration key 96 when the user agrees to the registration, or the user operates the non-registration key 98 when the user does not agree to the registration. When registering the mobile address book data, the user also needs to set to whom the access right to the registered mobile address book data is granted as indicated in the message 94.

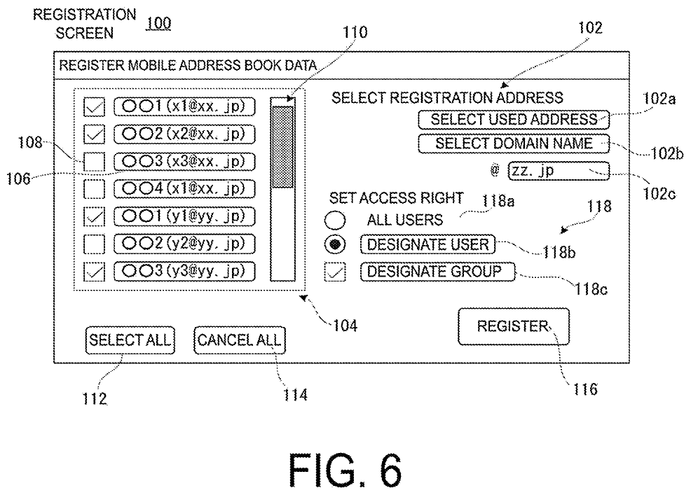

FIG. 6 illustrates an example of a registration screen displayed next on the display 54 when the registration key 96 is operated.

The registration screen 100 includes a selector 102 for selecting an address to be registered. The selector 102 includes a used address selection key 102a for selecting, for example, an address used for the image transmission described above and a domain name selection key 102b for specifying and selecting a domain name, and a domain name display 102c for displaying the selected domain is provided below the domain name selection key 102b.

A decider 104 occupies almost the left half of the registration screen 100. The decider 104 is a region for deciding an email address to be registered in the information processing apparatus 12, a plurality of address displays 106 are formed in line in the up-down direction, and a check box 108 is provided corresponding to each address display 106. The e-mail address marked with a check mark in the check box 108 is registered.

A scroll key 110 is provided on the right side of the address displays 106 of the decider 104. The scroll key 110 can be used to display undisplayed addresses in the address displays 106.

When an all selection key 112 provided below the decider 104 is operated, all the addresses displayed in the address displays 106 are brought into a selected state, and check marks are entered in all the check boxes 108.

Conversely, when an all cancel key 114 is operated, all the check marks in the check boxes 108 can be removed.

When a mail address decided by the decider 104 is registered, a registration key 116 is operated.

On this registration screen 100, it is necessary to also register who may use the mail address registered in this way, that is, to whom the access right to the registered mail address is granted. For this reason, an access right configurator 118 is provided.

The all-user configurator 118a is operated in a case where the access right is granted to anyone, but when the user who has selected to register the e-mail address designates to whom the access right is granted, details of the designation is displayed in a designation display 118c by operating a user designator 118b. In the illustrated example, a check mark entered on the left side of the designation display 108b indicates that the user has designated the group.

The access right configurator 118 may set the access right for each registered address or may collectively set the access right for all the registered addresses.

As in this example, if (presence/absence of) the access right to the mobile address book data is registered along with the mobile address book data, utilization of the registered mobile address book data can be appropriately managed.

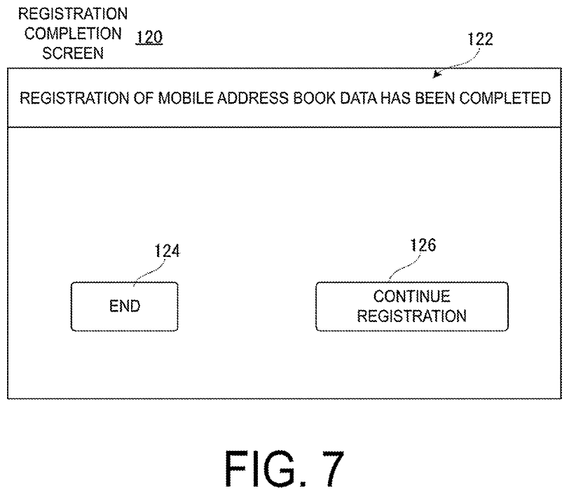

When the registration of the mobile address book data is completed on the registration screen 100, the registration completion screen 120 illustrated in FIG. 7 is displayed. On the registration completion screen 120, a message 122 informs the user that the registration of the mobile address book data is complete, and the user is asked whether or not to continue the registration. In other words, an end key 124 is operated to end the registration of the mobile address book data, or a continue key 126 is operated to continue the registration.

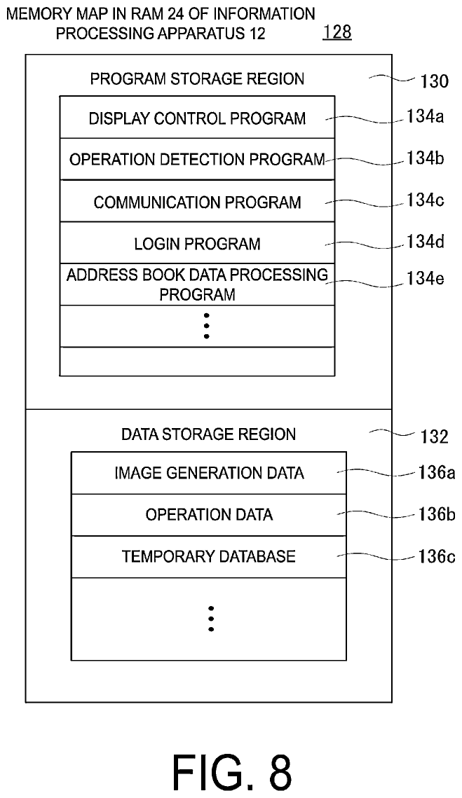

FIG. 8 is a graphic diagram illustrating an example of the memory map 128 in the RAM 24 of the information processing apparatus 12 illustrated in FIG. 2. As illustrated in FIG. 8, the RAM 24 includes a program storage region 130 and a data storage region 132. A control program for the image processing apparatus including an OS is stored in the program storage region 130 of the RAM 24. The control program for the image processing apparatus also includes a display control program 134a, an operation detection program 134b, a communication program 134c, a login program 134d, an address book data processing program 134e, and the like.

The display control program 134a is a program that generates display screen data necessary for displaying various screens on the screen of the display 54 on the basis of image generation data 136a described below, and a program that cause the display control circuit 30 to display images on the display 54 using the display screen data.

The operation detection program 134b is a program for detecting operation data (which will be described below) 136b corresponding to an operation on the input device 52. For example, when the touch panel (not illustrated) is touched, the CPU 22 acquires touch coordinate data output from the touch panel as the operation data 136b in accordance with the operation detection program 134b and stores the data in the data storage region 132 of the RAM 24.

The communication program 134c is a program for controlling the near field communicator 38 and the communicator 50 and communicating with the mobile terminal 14, other computers, and the like directly by using Bluetooth (or via a network (not illustrated)).

The login program 134d is a program for the mobile terminal 14 to log in to the information processing apparatus 12 using Bluetooth, for example, to perform user authentication.

The address book data processing program 134e is a program for registering the mobile address book data in the temporary database 136c from the mobile terminal 14 logged in and deleting the registered address book data therefrom.

Note that although not illustrated in the drawing, other programs necessary for operations of the information processing apparatus 12 are set in the program storage region 130.

The image generation data region 136a, the operation data region 136b, the temporary database 136c, and the like are formed in the data storage region 132 of the RAM 24. It should be noted in advance that the term “region” in the following description may be omitted when referring to each region, and each region may be indicated by the same reference sign as that of the region corresponding to each piece of data.

The image generation data 136a is data such as polygon data or texture data for generating display image data corresponding to various screens displayed on the display 54. The image generation data 136a includes image data corresponding to a software key, and an image generation data for displaying each screen described below.

The operation data 136b is operation data detected in accordance with the operation detection program 134b and stored in a time-series manner. This operation data is used when the CPU 22 determines what operation the user has performed in a case where executing processing described below. Note that the operation data 136b is deleted after being used for the processing of the CPU 22.

The temporary database 136c temporarily saves necessary information (such as a name, a facsimile number, an email address, and the like) and temporarily saves image data to transmit image, and temporarily registers the history of transmission that have executed the image transmissions.

Although not illustrated in the drawing, the data storage region 132 stores other data necessary to execute the control program for the information processing apparatus and is provided with a timer (counter) and a register necessary to execute the control program for the information processing apparatus.

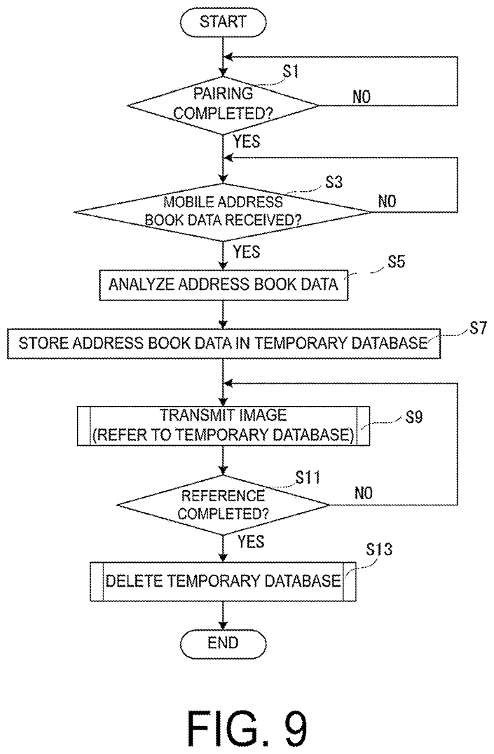

FIG. 9 is a flowchart schematically illustrating operations performed by the CPU 22 (FIG. 2) when image transmission (facsimile transmission or email transmission) is executed from the information processing apparatus 12 using the mobile address book data of the mobile terminal 14 in the information processing system 10 (FIG. 1) according to the example. At this time, the CPU 22 displays the image transmission screen 74 illustrated in FIG. 4 on the display 54 of the information processing apparatus 12. The CPU 22 gives a command to the near field communicator 38, for example, and starts near field communication connection processing with the mobile terminal 14. For Bluetooth connection, pairing processing is executed by setting a device name and PIN code of the mobile terminal 14.

The wireless connection to the mobile terminal 14 may be executed by wireless LAN connection or near field communication (NFC).

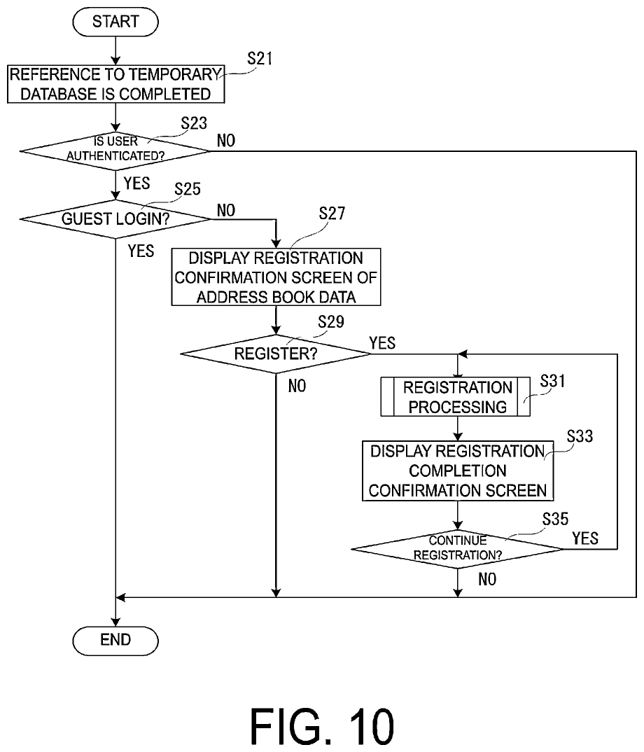

It should be noted in advance that the operations illustrated in FIG. 9 and the operations illustrated in FIGS. 10 to 12 are basically controlled in accordance with the address book data processing program 134e (FIG. 8).

In first Step S1, the CPU 22 determines whether or not pairing for Bluetooth communication, for example, with the mobile terminal 14 is completed.

When successfully paring with the information processing apparatus 12, the mobile terminal 14 transmits the mobile address book data from the RAM 60 or the auxiliary storage 62 (FIG. 3) of the mobile terminal 14 to the information processing apparatus 12. Thus, when “YES” is determined in Step S1, in next Step S3, the CPU 22 determines whether the mobile address book data is received.

When “YES” is determined in Step S3, the CPU 22 analyzes the received mobile address book data in next Step S5 and saves necessary information (a name, a facsimile number, an email address, and the like) in the temporary database 136c in Step S7. Thereafter, when the mobile address book data is referred to, the data in the temporary database 136c is referred to.

The transmission data from the mobile terminal 14 may be collectively transmitted in a file format of vCard, or may transmitted in parts such as splitting transmission in which packet data split into appropriate sizes is transmitted, analyzed on the information processing apparatus 12 side, and stored in the temporary database 136c, and this processing is repeated. When the transmission data is transmitted in the file format, the file received is deleted at the timing at which creation of the temporary database 136c is completed or the temporary database 136c is deleted.

In next Step S9, the CPU 22 controls the communicator 50 in accordance with the communication program 134c and executes the image transmission job. At this time, once the user operates the mobile address book reference key 78b on the image transmission screen 74 in FIG. 4, the image transmission destination is set with reference to the address book data saved in the temporary database 136c, and the image transmission job is executed. Next, the mobile address book data stored in the temporary database 136c is referred to again when another job is subsequently performed.

When it is determined in Step S11 that there is no need to refer to the mobile address book data, the mobile address book data saved in the temporary database 136c in Step S13 is deleted, and the image transmission job ends.

Next, the operations of the CPU 22 for registering, in the main body of the information processing apparatus 12, the mobile address book data saved in the temporary database 136c will be described with reference to FIG. 10. That is, a registration confirmation screen 92 (confirmation dialog) illustrated in FIG. 5 is displayed in regard to whether to register the mobile address book data in the main body (for example, the RAM 24 or the auxiliary storage 26) of the information processing apparatus 12 at the same timing (when logging out) as the deletion of the mobile address book data in Step S13. The registration confirmation screen 92 is not displayed at the time of automatic logout due to elapse of time.

When the reference to the temporary database 136c ends in Step S11 in FIG. 9 or in Step S21 in FIG. 10, in Step S23, the CPU 22 determines whether user authentication is performed for the user of the mobile terminal 14 in the image transmission job at that time. Thus, Step S23 configures the first determiner (that determines whether the user authentication is performed) for registering the mobile address book data.

Whether the user authentication is performed can be determined depending on whether information unique to the user, such as a user name or a user ID, is saved in the temporary database 136c, for example.

When “NO” is determined in Step S23, that is, when the second determination that the user authentication is not performed is made, then the processing ends.

When “YES” is determined in Step S23, that is, when the first determination that the user authentication is not performed is made, next Step S25 determines whether the user authentication is logged in as a guest, that is, determines whether the user authentication is performed simply for acquiring a guest account. When “YES” is determined in Step S25, that is, when the user authentication is simply logged in as a guest, then the processing ends.

When “NO” is determined in Step S23, that is, when the official user authentication is performed for the user (mobile terminal 14), the registration confirmation screen 92 illustrated in FIG. 5 is displayed in next Step S27. Then, whether the registration key 96 in the registration confirmation screen 92 is operated is determined in Step S29. When the registration key 96 is not operated or a non-registration key 98 is operated, “NO” is determined in Step S29, and the processing ends in this case.

When “YES” is determined in Step S29, that is, when the registration key 96 in the registration confirmation screen 92 is operated, the registration screen 100 illustrated in FIG. 6 is displayed, and registration processing is executed thereon in next Step S31.

In the registration processing using the registration screen 100, once the user selects an address used for image transmission or selects an address to be registered after designating, a domain name using the selector 102, the selected address is displayed on the decider 104. Once the mail address to be registered is decided by entering a check mark in a corresponding check box 108, and then the registration key 116 is operated, the decided address is registered.

On the registration screen 100, it is also necessary to register to whom the access right to the registered mail address is granted. In a case where the access right is granted to anyone, the all-user configurator 118a is operated. In a case where the access right is granted to a limited number of people, the user designator 118b designates them.

The thus registered mobile address book data and the associated access right data are stored in the RAM 24 and/or the auxiliary storage 26 of the information processing apparatus 12.

Then, in Step S33, the registration completion screen 120 illustrated in FIG. 7 is displayed to confirm whether to continue the of the mobile address book data. When the continue key 126 is operated, the processing returns to the previous Step S31, the registration screen 100 is displayed again, and the registration processing described above is executed.

When an operation of the end key 124 in the registration completion screen 120 is confirmed, data “NO” is determined in Step S35, and the processing of registering the mobile address book data saved in the temporary database 136c in the main body ends.

In this manner, when the determination result in Step S23 is the first determination, that is, when the user authentication is performed, the registrator (configured of Steps S27 to S35) registers, in the information processing apparatus 12, the mobile address book data in the temporary database. However, when the determination result in Step S23 is the second determination, that is, when the user authentication is not performed, the registrator does not register the mobile address book data in the information processing apparatus 12. Conversely, the mobile address book data can be registered in the main body of the information processing apparatus when the user authentication is performed, and thus user convenience is further improved.

In this manner, one feature of the example is to respond differently to whether or not the mobile address book data is registered in the information processing apparatus 12 depending on whether or not the user authentication is performed.

Another feature of the example is to control a timing at which the mobile address book data saved in the temporary database 136c is erased or deleted.

In a case of an information processing apparatus on which the user authentication is not performed, it is not possible to distinguish who is the user currently operating the information processing apparatus. Therefore, there is a security problem that if the user leaves the information processing apparatus without explicitly deleting the mobile address book data, another user may view the data.

Thus, in this example, in a case where user authentication is not performed, the information processing apparatus automatically deletes the mobile address book data from the temporary database 136c at any timing of the following timings.

A first timing is, for example, when the reset key 84 is operated on the image transmission screen 74 illustrated in FIG. 4, a second timing is, for example, when the user transitions to a screen other than the image transmission screen 74 (transition to another job) by touching the home icon 88 or operating the copy key 90 on the image transmission screen 74, and a third timing is automatic clear due to elapse of time. As described above, it is desirable to delete the mobile address book data at any timing of the above-described first to third timings in terms of security in the case where the user authentication is not performed.

On the other hand, when the deletion is performed at a timing that is not intended by the user such as in a case where it is desired to refer to the mobile address book data using the image transmission function again after touching the home icon 88 to transition to another screen such as a home screen, for example, it becomes necessary to transfer the mobile address book data again, which impairs convenience.

Thus, in the example, it is possible to distinguish the user who is currently operating the information processing apparatus 12 in a case where the user authentication is performed (which may include a guest account), and the user is logging in during the operation by the user, and thus it is possible to improve the convenience by logging out at the timing at which the mobile address book data is deleted (including automatic logging out due to elapse of time).

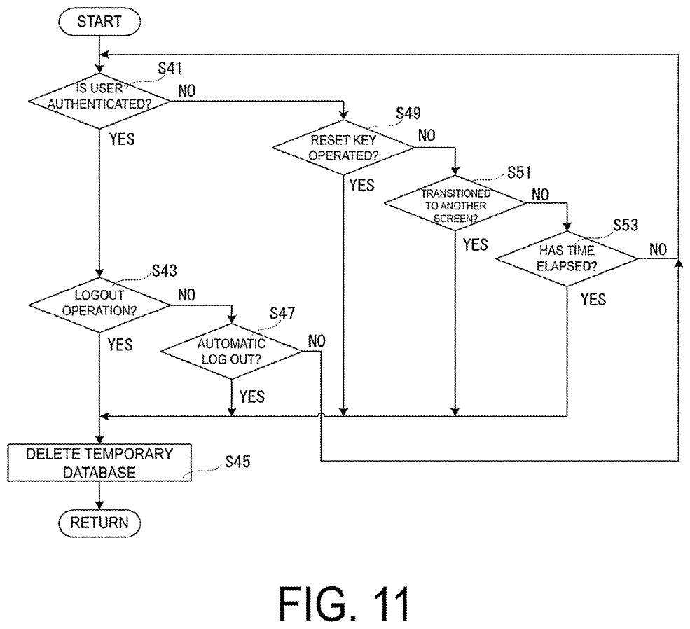

Operations of the CPU 22 and the like when the mobile address book data is deleted according to the example will be described with reference to the flowchart in FIG. 11 that illustrates Step S13 in FIG. 9 in detail. The data saved in the temporary database 136c deleted here may include not only the mobile address book data but also image data transmitted in the image transmission screen job and transmission history data.

Information regarding connection to the mobile terminal (pairing information or the like in Bluetooth connection) is deleted, for example, at a timing at which the transfer of the mobile address book data is completed on the image transmission screen 74. In a case where the connection information is not deleted at this timing, such connection information may be saved together with the mobile address book data and the like in the temporary database 136c and may be deleted together with the mobile address book data by deleting the temporary database 136c.

In first Step S41 in FIG. 11, the CPU 22 determines, from login information, whether the user authentication is performed for the user of the mobile address book data currently saved in the temporary database 136c. Step S41 configures the first determiner (which determines whether the user authentication is performed) when the user temporary database is deleted.

When “YES” is determined in Step S41, that is, when the first determination that the user is authenticated is made, whether the user has logged out is determined in next Step S43.

Note that since Step S41 configures the first determiner that is same as or similar to that in Step S23 above, it is also possible to save the determination result in Step S23 by a flag (not illustrated) or the like, for example, and omit Step S41.

When “YES” is determined in Step S43, that is, when the user authenticated has logged out, the mobile address book data or the like in the temporary database 136c is deleted.

When “NO” is determined in Step S43, that is, when it is determined that an explicit logout operation is not performed, the CPU 22 determines in Step S47 whether there is an automatic logout due to elapse of time.

When “YES” is determined in Step S47, the mobile address book data and the like in the temporary database 136c are deleted in Step S45.

In this manner, in the example in FIG. 11, when the user authentication is performed, the temporary database 136c is deleted when logout is determined by the second determiner, for example, in Step S43 or S47, that is, when the user is logged out by an explicit operation or automatically logged out due to elapse of predetermined time.

Furthermore, when “NO” is determined in Step S41 above, that is, when it is determined that user authentication is not performed for the user who is operating the information processing apparatus 12 at that time, whether the reset key 84 has been operated is determined in Step S49. In Step S49, the CPU 22 determines whether the reset key 84 has been operated at the aforementioned first timing. When “YES” is determined in Step S49, the mobile address book data and the like in the temporary database 136c are deleted in Step S45.

In a case where “NO” is determined in Step S49, the CPU 22 determines in next Step S51 whether the timing corresponds to the second timing, that is, whether the screen is transitioned from the image transmission screen 74 to another screen. When “YES” is determined in Step S51, the mobile address book data and the like in the temporary database 136c are deleted in Step S45.

When “NO” is determined in Step S51 as well, whether the predetermined time has elapsed is determined in Step S53. In Step S53, the elapse of the predetermined time is determined with reference to a timer (counter) set in the data storage region 132 (FIG. 8) in the RAM 24, for example. Then, when the elapse of the predetermined time is detected, the mobile address book data and the like in the temporary database 136c are deleted in Step S45.

Note that when “NO” is determined in Step S53 as well, the processing returns to Step S41.

As described above, in the example, the temporary database is forcibly deleted under a predetermined condition for a user who is not authenticated, regardless of whether the user has logged out, so that the mobile address book data and the like saved in the temporary database can be kept secret from others who will later use the information processing apparatus. This avoids unauthorized use of the mobile address book data.

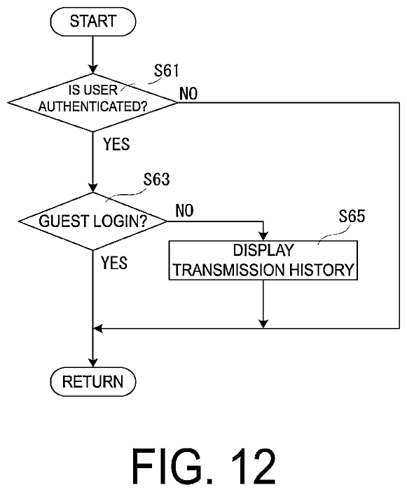

FIG. 12 illustrates operations performed when the user wants to see the transmission history. In other words, Step S61 in FIG. 12 determines whether or not the user authentication is performed. In a case where “YES” is determined in Step S61, the CPU 22 further determines whether the user has logged in as a guest, that is, whether the user is a guest account user in Step S63. When “YES” is determined in Step S63, the processing returns.

When “NO” is determined in Step S63, the transmission history is displayed on the display 54 in Step S45.

In other words, although the mobile address book data is not stored in the temporary database 136c or the like, since the address is stored as a destination of the image transmission job, in Step S61, as long as it is determined that the user authentication is performed, and the user logged in as a guest, the CPU 22 displays only the job transmission history executed by the user.

Note that, in the above-described example, although the image transmission job has been described as an example as a job executed by the information processing apparatus 12 as an assumption of determining whether to delete the mobile address book data of the mobile terminal 14 saved in the temporary database, the job executed by the information processing apparatus 12 using the mobile address book data of the mobile terminal 14 is not limited to the image transmission job.

The specific configurations and the like exemplified in the above example are examples, and can be changed as appropriate according to an actual product. Moreover, the order in which each step in the flowcharts illustrated in the above-described example is processed can be changed as needed, as long as the same results are obtained.

### REFERENCE SIGNS LIST

10 Information processing system
12 Information processing apparatus
14 Mobile terminal
22, 58 CPU
74 Image transmission screen
78 Address referencer
92 Registration confirmation screen
100 Registration screen
102 Registration address selector
104 Decider
118 Access right configurator
120 Registration completion screen
134e Address book data processing program
136c Temporary database

1. An information processing apparatus that saves, in a temporary database, mobile address book data of a mobile terminal, the information processing apparatus comprising:
a job executor that refers to the mobile address book data saved in the temporary database to execute a job;
a first determiner that makes a first determination when user authentication is performed for a user of the mobile terminal or makes a second determination when the user authentication is not performed; and
a deleter that deletes the temporary database at a respective timing in accordance with a determination result of the first determination or the second determination of the first determiner after the job executor finishes referring to the mobile address book data.

2. The information processing apparatus according to claim 1, further comprising:
a second determiner that determines whether the user authenticated has logged out,
wherein when the determination result of the first determiner is the first determination, the deleter deletes the temporary database at a timing at which the second determiner determines that the user authenticated has logged out.

3. The information processing apparatus according to claim 1, further comprising:
a storage capable of registering the mobile address book data; and
a registrator that registers the mobile address book data to the storage when the determination result of the first determiner is the first determination,
wherein the mobile address book data is not registered to the storage when the determination result of the first determiner is the second determination.

4. The information processing apparatus according to claim 3, wherein the registrator also registers an access right to the mobile address book data.

5. The information processing apparatus according to claim 1, wherein the deleter deletes the temporary database at any timing of a first timing at which the job is reset, a second timing at which transition to another job is performed, and a third timing at which a predetermined time has elapsed, when the determination result of the first determiner is the second determination.

6. An information processing program for an information processing apparatus that saves, in a temporary database, mobile address book data of a mobile terminal, the program causing a CPU of the information processing apparatus to operate as:
a job executor that refers to the mobile address book data saved in the temporary database to execute a job;
a determiner that makes a first determination when user authentication is performed on the mobile terminal or makes a second determination when the user authentication is not performed; and
a deleter that deletes the temporary database at a respective timing in accordance with a determination result of the first determination or the second determination of the determiner after the job executor finishes referring to the mobile address book data.

7. An information processing method for an information processing apparatus that saves, in a temporary database, mobile address book data of a mobile terminal, the method comprising:
referring to the mobile address book data saved in the temporary database to execute a job;
making a first determination when user authentication is performed on the mobile terminal and making a second determination when the user authentication is not performed; and
deleting the temporary database at a respective timing in accordance with a determination result of the first determination or the second determination in the step of making a first determination and the second determination after finishing reference to the mobile address book data in the step of referring to the mobile address book data.
